(19) United States
(12) Patent Application Publication
(10) Pub. No.: US 2012/0054029 A1
(43) Pub. Date: Mar. 1, 2012

(54) ADVERTISING BASED MEDICAL DIGITAL IMAGING

(76) Inventors: Michael E. Trice, Clarksville, MD (US); Carl Hixson, Chatham, NJ (US)

(21) Appl. No.: 13/194,897

(22) Filed: Jul. 29, 2011

Related U.S. Application Data
(60) Provisional application No. 61/368,927, filed on Jul. 29, 2010.

(51) Int. Cl. G06Q 30/02

(52) U.S. Cl. 705/14.49; 705/14.4

(57) ABSTRACT

A method for providing a medical digital image on a device including: receiving the medical digital image from an image depot, receiving an advertisement, presenting the advertisement on a display of the device, and presenting the medical digital image on the display of the device.

### CROSS-REFERENCE TO RELATED PATENT APPLICATIONS

This application claims the benefit of U.S. Provisional Patent Application No. 61/368,927, entitled “A business model that uses an online advertising revenue model to provide a low cost medical digital imaging subscription service,” filed on Jul. 29, 2010, which application is incorporated herein by reference in its entirety.

### BACKGROUND OF THE INVENTION

1. Field of the Invention

The present invention relates generally to providing data, and more particularly to systems, methods, and computer-program products for providing medical digital images.

2. Related Art

Medical care often requires imaging to determine patients' problems as well as the correct course of action for treating them. However, physicians and other care providers, e.g., orthopedic surgeons, etc, are often off-site when patients visit the hospital with injuries requiring treatment. While their expertise is often necessary to optimize patient care, often off site care providers cannot provide or oversee optimal care without imaging, e.g., x-rays, magnetic resonance imaging (MRI), pictures of patients' injuries, etc. While the internet and technology may be used to enable offsite care providers to access images for providing care, most hospitals and most of the orthopedic community have limited access to digital imaging solutions for this problem. In fact, there are few applications available for care providers to access radiographic and other images while on call from outside of the hospital and only a minority of care providers and hospitals have implemented these applications.

### SUMMARY OF THE INVENTION

In an illustrative embodiment of the present invention, a method and computer readable medium are disclosed.

A method for providing a medical digital image on a device according to an embodiment of the current invention includes receiving the medical digital image from an image depot, receiving an advertisement, presenting the advertisement on a display of the device, and presenting the medical digital image on the display of the device.

Another method for providing a medical digital image according to an embodiment of the current invention includes receiving a medical digital image from an image provider, receiving an advertisement from an advertisement device, determining that the medical digital image should be sent to a user device, sending the medical digital image in response to the determination, and sending the advertisement to the user device in response to the determination.

A medium according to an embodiment of the current invention includes holds computer-executable instructions for operating a programming environment using a computer, where the instructions include instructions for receiving a medical digital image from an image provider, associating the medical digital image with a user account, receiving an advertisement from an advertisement device, receiving an image request associated with a user of a user device, verifying that the user associated with the user device corresponds with the user account associated with the image request, sending the medical digital image based on the verification, and sending the advertisement to the user device based on the sending of the medical digital image.

Further features and advantages of the invention, as well as the structure and operation of various exemplary embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings, wherein like reference numbers generally indicate identical, functionally similar, and/or structurally similar elements.

FIG. 1 illustrates an exemplary block diagram of an advertising based medical digital imaging system according to an exemplary embodiment of the present invention;

FIG. 2 illustrates exemplary processing for providing medical digital imaging according to an exemplary embodiment of the present invention; and

FIG. 3 illustrates a computer system that may be configured to practice an exemplary embodiment of the present invention.

### DETAILED DESCRIPTION OF THE INVENTION

One embodiment of the present invention facilitates telemedicine to allow a care provider to provide medical care remotely from a provider of a medical digital image.

There are two main factors that limit access for most care providers to digital images that would optimize patient care. First, the costs of such systems are prohibitive for most care providers. Second, while applications for general image transmission are available, few applications are tailored to the needs of the on-call or off site physician.

Conventional systems for medical digital image transmission place the burden of cost from access to digital imaging on hospitals and/or care providers. Hospitals that want to provide Picture Archiving and Communication System (PACS) and other digital imaging services to care providers (e.g., orthopedic surgeons) must pay either large upfront costs and/or relatively large subscription fees. If the hospitals are unwilling to underwrite these costs, the care providers must do so. Since hospitals and care providers generally have limited financial reserve, the investment capital necessary to provide or obtain access to digital imaging is often unavailable. Consequently, conventional technological solutions to provide medical imaging access for off-site physicians are not economically practical.

An exemplary embodiment of the present invention solves the problem of excessive costs for access to medical digital imaging in two ways. First, it uses a subscription model for a digital imaging service that provides immediate access to images taken at emergency rooms, hospitals, urgent cares, etc. In contrast to many of the current PACS systems that require upfront expenditures from hundreds of thousands of dollars to millions of dollars, the embodiment employs a “pay as you go” subscription service for a nominal fee. The second feature is that the embodiment derives revenue stream from sales of online advertisements that are delivered to a target audience in concert with image transmission. Since a large proportion of revenue comes from advertising, subscription costs can be minimized or eliminated. The embodiment solves the problem of a relative void in care provider specific digital imaging applications by providing a low cost, easy to use application readily accessible by cell phones and other mobile computing alternatives. Again since revenue is derived from advertising, this care provider specific application can be provided for a nominal cost.

Online advertising revenue offsets the costs of medical digital imaging services. The system of the present invention transfers the expense of providing digital imaging access to advertisers. Online advertisement revenue not only underwrites the cost of image transmission and access, but makes low cost applications for modern cell phones and mobile computers both feasible and profitable. With online advertising revenue, a profit on the sale of the “application” enabling the medical digital imaging may not be needed. With each application purchased or contracted, the system increases the targeted audience it can deliver to its advertising clients. Thus, the system utilizes low cost applications for digital imaging to increase profit margins for the imaging service provider while simultaneously decreasing costs to hospitals, care providers, and our healthcare system.

Digital imaging access may be provided in a variety of ways. A provider may use the internet or online advertisement as a primary or secondary source of revenue. Profit in internet advertisement is based on the sale of access of target audiences to advertisers. Hospitals, off-site care providers, and on site care providers in different locations that require image transmission are a captive and reproducible target audience.

Hospitals and care providers have varied capacity with regards to image access. Some have no investment in digital imaging and some have expensive comprehensive systems. Image depot 102 provides digital imaging access to care providers without regard to their prior or current capacity. Image depot 102, which employs online advertising, may attract hospitals and/or care providers to switch from a conventional service provider because of cost savings, and similarly, may cause care providers to switch their cellular phone service because of a less expensive plan.

Conventional imaging service providers generally make their profits by selling expensive PACS (Picture Archiving and Communications Systems.) and, therefore, do not have an incentive to conceptualize or adopt an advertising based medical digital imaging system. These companies depend on limited access and increased demand to drive their profit model. The implementation of another model that offers widespread access to this technology for minimal cost would directly undermine profits from their established business. In the advertising based model described herein, increased access results in increased ads and consequently increased revenue for an advertising based image service provider. In contrast, increased access will decrease demand for the services of conventional providers, resulting in decreased sales profits for conventional providers Additionally, the introduction of a low-cost advertising based imaging will also take away market share of conventional imaging service providers, further reducing their revenues.

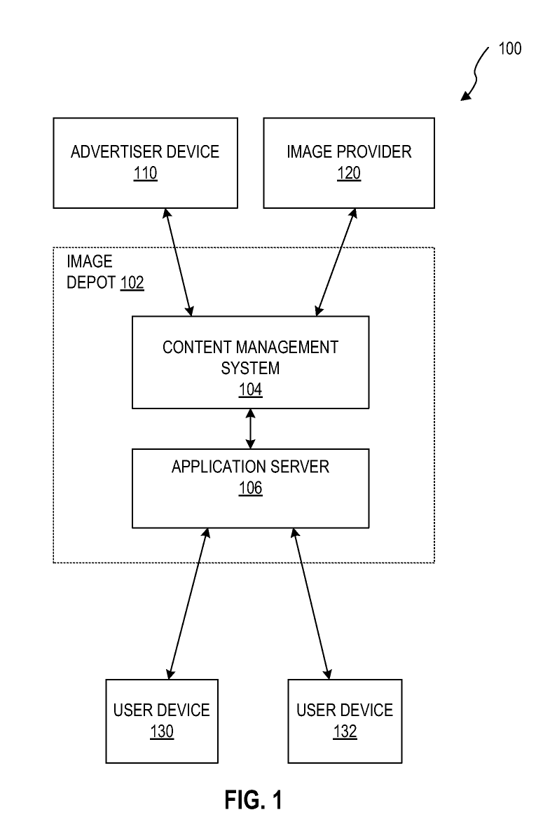

FIG. 1 illustrates an exemplary block diagram of an advertising based medical digital imaging system 100 according to an exemplary embodiment of the present invention. System 100 includes image depot 102, advertiser device 110, image provider 120, user device 130, and user device 132.

Image depot 102 is a computing device which manages advertisements, medical digital images, and communications between advertiser device 110, image provider 120, user device 130, and user device 132. Advertisements include wallpaper advertisements, video advertisements, pop-up advertisements, polite advertisements, interstitial advertisements, etc. Medical digital images include a single two-dimensional image, a single three-dimensional image, a still image, a group of images, a series of images, a video, etc. Medical digital images include: radiographs and other more advanced medical imaging, e.g, X-ray computed tomography (CT), MRI, etc., and photographic based images.

Image depot 102 also ensures security of at least one of advertisements, medical digital images, or communications. For example, image depot 102 encrypts data stored within image depot 102 and encrypts communications sent by image depot 102. Image depot 102 may also authenticate and/or authorize access to image depot 102 by at least one of advertiser device 110, image provider 120, user device 130, or user device 132. In one embodiment, image depot 102 also provides for collaboration between a user of user device 130 and a user of user device 132.

Image depot 102 includes content management system 104 and application server 106. Content management system 104 permits communications to be established with advertiser device 110 and image provider 120. Content management system 104 additionally manages the storage and transmission of advertisements, digital medical images, information regarding the advertisements, and digital medical images. For example, in one embodiment content management system 104 determines the advertisement transmitted to user device 130 based on at least one of the contents of the medical digital image, patient data associated with the medical digital image, user data associated with a user authorized to receive the medical digital image, or user device data. Patient data includes at least one of name, age, height, weight, race, address, medical history, etc. User data includes at least one of name, age, height, weight, race, address, medical speciality, etc. User device data includes at least one of type of device, applications installed on device, device history usage, device location, etc. Application server 106 of image depot 102 handles communications between image depot 102, user device 130 and/or user device 132.

Advertiser device 110 is a computing device which enables an advertiser to transmit advertisements to image depot 102. Advertising device 110 includes an interface where the advertiser may specify the advertisement to transmit to image depot 102. Advertising device 110 may also include an interface where the advertiser may specify preferences or criteria for when or how the advertisement may be displayed on user device 130 and transmit the specifications to image depot 102. Advertising device 110 may additionally provide an interface for advertisers to view data regarding the presentation of the advertisement and pay for the advertising. Advertising device 110 may be owned by an owner of image depot 102 or a separate entity of a web based or other advertising business or service with which the owner of image depot 102 contracts or employs to derive advertising revenue. In one embodiment, advertiser device 110 directly transmits advertisements to user device 130.

Image provider 120 is a device which enables medical digital images to be sent to image depot 102. Image provider 120 is capable of generating a medical digital image or a computing device capable of receiving a medical digital image generated by an imaging device. Image provider 120 may be a PACS machine, digital x-ray machine, scanner, camera, server, home and business computer, mobile computer, mobile phone, other mobile computing devices, e.g., NetPads, iPads, etc. For example, image provider 120 may be an iPad with an application installed from Apple's App Store which enables the iPad to send medical digital images to image depot 102. Image provider 120 may be owned by or located in a hospital, but may also be located in a clinic, doctor's office, health center, etc. The user of an image provider may be a technician, technologist, nurse, health care provider, etc. Image provider 120 may also receive advertisements from image depot 102 and may present the received advertisements to a user of image provider 120. Image provider 120 may also include an interface where the user of image provider 120 may indicate a patient associated with a medical digital image. The interface may also permit the user to indicate a care provider authorized to view data and/or images regarding the patient.

User device 130 is a computing device which enables advertisements and medical digital images to be presented to a user of user device 130, e.g., a health care provider. For example, user device 130 may be a mobile phone, mobile or personal computer, or other mobile computing devices, e.g., NetPads, iPads, etc. For example, user device 130 may be an iPad with an application installed from Apple's App Store which enables the iPad to present advertisements and medical digital images to a user. User device 130 receives advertisements and medical digital images from image depot 102 and presents the advertisements and medical digital images to the user via a display of user device 130.

User device 132 is a device used by a second user of system 100 similar to user device 130. User device 132 and user device 130 are used so that the user of user device 130 and the user of user device 132 may collaborate together. For example, a medical digital image may be sent to both user device 130 and user device 132. The two users may then communicate with each other to make a decision on medical care based on the medical digital image. System 100 may also include additional user devices which may correspond to additional users of system 100.

Image depot 102, advertiser device 110, image provider 120, user device 130, and user device 132 are in communication via the internet. However, communication may also be established via other configurations, for example, direct connections, an intra-net, or a combination.

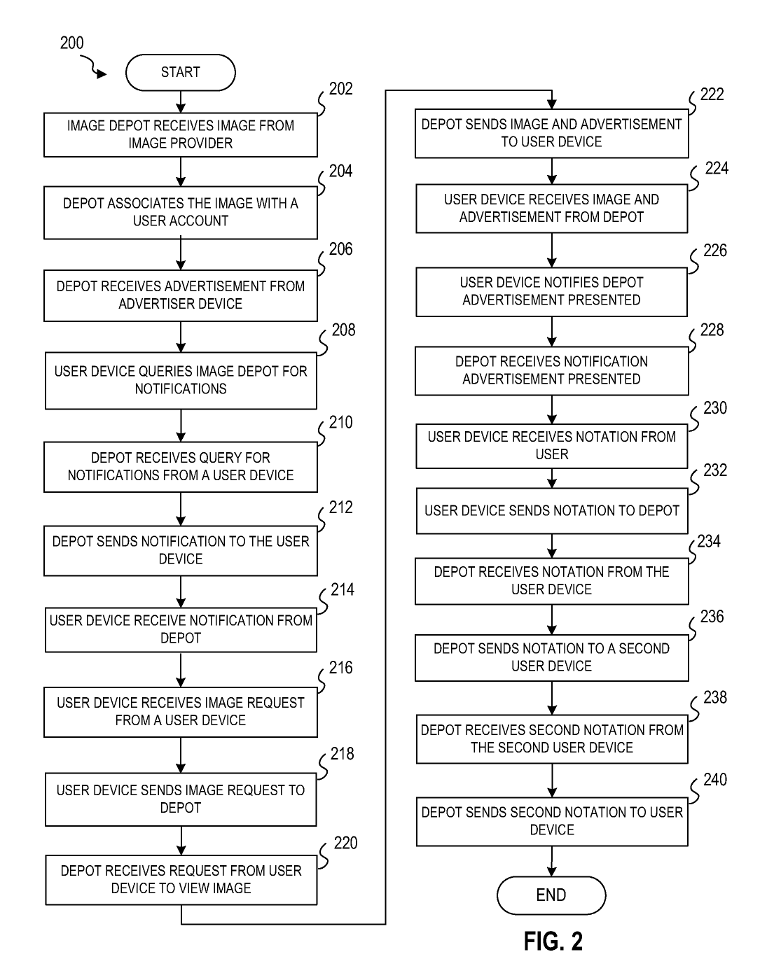

FIG. 2 illustrates exemplary processing 200 for providing medical digital imaging according to an exemplary embodiment of the present invention.

Process 200 begins with image depot 102 receiving a medical digital image from image provider 120 (block 202). The medical digital image may be an image obtained directly from a medical imaging device, e.g., an X-ray machine, a MRI machine, etc. The medical digital image may also be an image obtained from a non-medical imaging device, for example, a photo of an X-ray or a photo of patient's injury captured by a point and shoot camera. The photo may be transferred onto image provider 120 from the non-medical imaging device and then transmitted to image depot 102. Image provider 120 may also transmit information to image depot 102 corresponding to the medical digital image. For example, image provider 120 may transfer information identifying the patient the medical digital image corresponds to, identifying one or more care providers authorized to view the medical digital image, etc.

Image depot 102 associates the image received from image provider 120 with a user account (block 204). The user account is an account of a care provider. Image depot 102 associates the image with the user account by storing data noting that the user account is authorized to access the medical digital image. Image depot 102 may also associate the medical digital image with a patient and associate the patient with the user account, thus indirectly associating the medical digital image with the user account.

Image depot 102 receives an advertisement from advertiser device 206 (block 206). Image depot 102 may also receive information specifying preferences or criteria for when or how the advertisement may be displayed. Image depot 102 associates the advertisement with an advertising account of the advertiser and stores the advertisement.

Image depot 102 may directly transmit an image with or without a voice or text message to user device 130, or notify user device 130 that a message and image is available to be seen. Additionally, a user of user device 130 may be notified by another means, e.g., phone call, text, page, etc., that an image/ message is available for review:

In another embodiment, user device 130 queries image depot 102 for notifications (block 208). Notifications include a notice to the user that an image that needs to be seen by a user of user device 130 has been received by image depot 102. User device 130 may query image depot 102 for notifications at intermittent intervals, for example, every minute.

Image depot 102 receives the query for notifications from user device 130 (block 210). Image depot 102 determines if a notification should be sent to user device 130. For example, image depot 102 may identify the user account associated with the query and determine if any medical digital images stored by image depot 102 and associated with the user account have not been viewed by the user, or if any medical digital images should be viewed by the user again. In an alternate embodiment, the image depot 102 determines if a notification should be sent to user device 130 when an image is received by image depot 102 from image provider 120, without first receiving a query for notifications from user device 130.

If image depot 102 determines a notification should be sent to user device 130, image depot 102 sends a notification to user device 130 (block 212). Examples of a notification include a text message, a Short Message Service (SMS) message, a Multimedia Messaging Service (MMS) message, an electronic mail, etc. Image depot 102 may also initiate a telephonic call to user device 130 to notify a user of an image.

User device 130 receives the notification from image depot 102 that an image needs to be viewed by the user of user device 130 (block 214). User device 130 presents the received notification to the user. The notification may be presented by an audio alert, a visual alert, or a tactile alert. For example, user device 130 may generate a sound, may display a pop-up message, or may vibrate.

User device 130 receives a request from the user to view the medical digital image (block 216). User provides the request to user device 130 through an interface of user device 130. For example, a displayed notification may include a button to click to view a medical digital image, and the user's click of the button is a request received by user device 130. In another example, the user may specify the patient or medical digital image the user desires to view.

User device 130 sends an image request to image depot 102 in response to receiving the request from the user (block 218). The image request includes information with which image depot 102 determines the medical digital image to transmit to user device 130. For example, the image request may specify one or more specific medical digital image to be transmitted to user device 130 or may specify a patient whose medical digital images are to be transmitted to user device 130.

Image depot 102 receives the request to view an image from user device 130 (block 220) and image depot 102 sends the image and an advertisement to the user device 130 (block 222). In sending, image depot 102 identifies one or more images to send to user device 130 based on the request and may also identify one or more advertisements to send to user device 130 based on at least one of the contents of a medical digital image, patient data associated with the medical digital image, user data associated with a user authorized to receive the medical digital image, or user device data. In one embodiment, image depot 102 sends an image and advertisement without receiving an image request from user device 130. For example, when sending a notification, image depot 102 may automatically also send the image associated with the notification and send an advertisement.

User device 130 receives the image and advertisement from image depot (block 224). The image and advertisement may be received at separate times. Advertisements may be presented to the target audience as a prelude to image transmission, during image transmission or after image transmission. In one embodiment, user device 130 displays the advertisement after the care provider is finished with viewing the image. For example, the image appears and the doctor makes a diagnosis. After the diagnosis is made, the doctor chooses to view an advertisement. In this example, the image may be sent by image depot 102 before the advertisement is sent by image depot 102.

In another embodiment, an advertisement is first sent by image depot 102 and the advertisement is displayed on user device 130 while the image is being received by user device 130. In this example, the advertisement may automatically disappear once the image has finished being received by user device 130. In yet another embodiment, the advertisement may remain on the display until the user closes the advertisement, enters an acknowledgement the user has viewed the advertisement, or navigates away from the advertisement. The user may also be given the option to delay presentation of an advertisement. For example, the user may select to view an advertisement before viewing an image or after viewing the image. For viewing an advertisement after an image, the user may choose to view the advertisement a duration of time after viewing the image, for example, a few minutes or hours.

In one embodiment, user device 130 displays the image even if an advertisement fails to be presented by user device 130, fails to be received by user device 130, or fails to be acknowledged by a user of user device 130. An advertisement may also be displayed on user device 130 when an application for viewing the images is launched on user device 130.

User device 130 notifies image depot 102 the advertisement was presented to the user (block 226). User device 130 sends the notification once the advertisement is displayed on user device 130. However, the notification may also be sent at a later point in time.

Image depot 102 receives the notification the advertisement was presented (block 228). Image depot 102 uses the notification to keep track of payment due by an advertiser for sending the advertisement to user device 130. Payment may also be tracked in other ways. Income may also be derived from advertisers in a number of ways. For example, income may be derived from payment based on cost per Mille (CPM) where advertisers pay for exposure of their message to a target audience, Cost per click (CPC) or pay per click where advertisers pay for each time someone clicks on their advertisement, Cost per visitor (CPV) where advertisers pay a fee for each visitor to their website, Cost per engagement (CPE) where advertisers pay when their advertisement is engaged, and Cost per action (CPA) where advertisers pay when an action is taken (e.g., a transaction is completed). Again, image depot 102 may interface with established advertising venues (e.g. Adsense, etc.) for advertiser and advertisement procurement, collection and distribution of advertising revenue, etc. Accordingly, in one embodiment, image depot 102 does not manage advertisements and advertiser device 110 directly interacts with user device 130 for the presentation of advertisements.

System 100 also enables real-time communication for diagnosis in a collaborative setting. Messages are communicated between user device 130 and user device 132. User device 130 user receives a notation from a user. For example, a notation may be a presumed diagnosis, a comment describing the history, physical exam, or other information. The notation may be comments regarding the medical digital image as well. The notation may also specify another user which the notation should be sent to. The notation is received by user device 130 from the user via an interface of user device 130.

User device 130 sends the notation to image depot 102 (block 232) and the notation is received by image depot 102 (block 234). The notation is associated with the medical digital image and/or patient and may be stored by image depot 102.

Image depot 102 sends the notation to second user device 132 (block 236). The second user device 132 may be a user device of a user which the notation was specified to be shared with, or may be a user device of a user who is authorized to access images of the patient. Image depot 102 sends the notation in real-time once the notation is received by image depot 102. In another embodiment, image depot 102 sends the notation when second user device 132 queries image depot 102 for notifications. In yet another embodiment, notification of the notation is first sent to second user device 132 and the notation is sent to second user device 132 in response to a request for the notation from second user device 132.

Image depot 102 receives a second notation from second user device 132 (block 238). The second notation is associated with the medical digital image and/or patient and stored by image depot 102.

Image depot 102 sends the second notation to user device 130 (block 240). The second notation is presented to the user on the display of user device 130.

Image depot 102 may ensure that all or some images, messages, notifications are especially encrypted to ensure privacy.

In one embodiment, image depot 102 also sends advertisements to image provider 120 so the advertisements are displayed on image provider 120.

Online advertisement revenue may also be generated from links to advertisements or websites. In one embodiment image depot 102 provides links to websites. Additional ads posted on these websites are sold to advertisers to derive an additional revenue stream. The same options described previously (e.g. CPM, CPC, CPA, etc.), are offered to advertisers at these linked websites.

In one embodiment, optimization of web traffic is achieved by cost minimization by providing access via either a subscription service model, single or multiple fees, or even for free. Traffic is also optimized by providing a user friendly interface including easy to use computer software or “applications” for cell phones and mobile computing devices. By minimizing cost and providing immediate and effortless access to images, traffic to the site is increased. Free and/or paid subscribers, or clients who pay an upfront cost have access. Convenient applications and ease of access ensure frequent site visitation, ensuring ad revenue since each site visit might allow for single, multiple ad revenue opportunities before, during and after image access. Revenue opportunities may also expand through links to other websites and additional fees and ads.

In one embodiment, as market share increases or image traffic increases, the costs of advertising are adjusted. Image depot 102 enables advertising space to be bid for by advertising device 110. Bidding by competing companies for advertisement space may make costs for advertisements flexible.

The elements of provisioning of web and digital medical image access service and/or interface and use of online advertising for all or part of the revenue stream may be modified to include types of arrangements that could be made with image access customers and how they pay for the access, if at all. Image depot 102 may need not to provide all of the image transmission. Image depot 102 may simply serve as a conduit for transmission. Image depot 102 may simply provide access to imaging from another server or company. Such an agreement may allow customers of other image transmission companies to utilize image depot 102 for a fee or for the purposes of increasing traffic and in so doing increasing ad revenue. Image depot 102 may interface with other applications, again with goals of increasing market share to increase ad revenues.

While one embodiment targets digital imaging transmission, internet advertising might be used in other forms of electronic medical records systems. For example, advertising might be linked to entire EMR systems, broadening advertiser access and in so doing, diminishing the cost to the care provider.

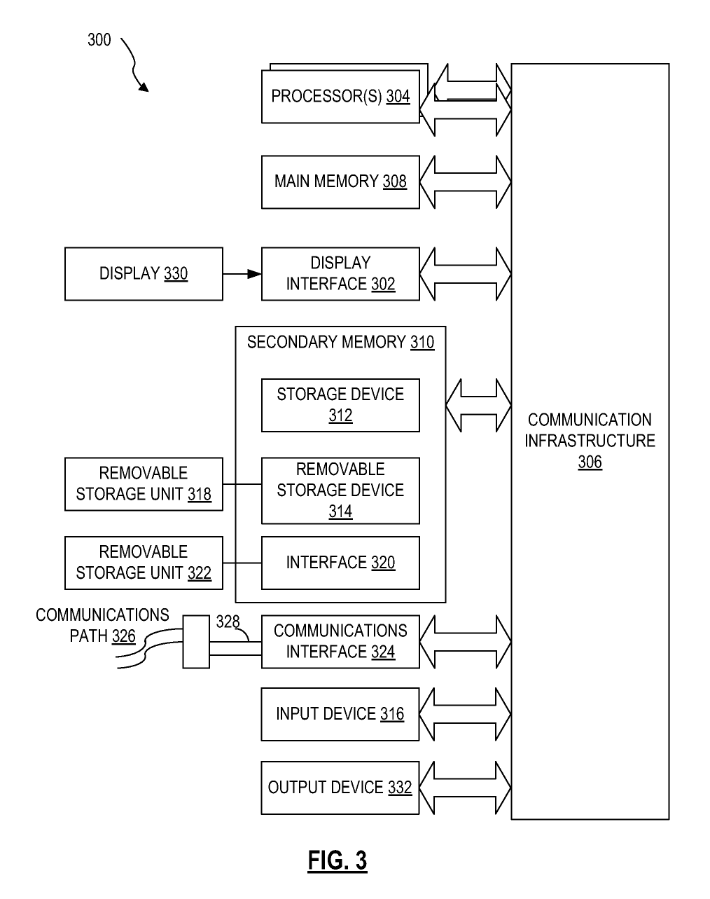

FIG. 3 illustrates a computer system that may be configured to practice an exemplary embodiment of the present invention. Image depot 102, advertising device 110, image provider 120, user device 130 and user device 132 may be implemented with one or more computer systems 300.

The present embodiments (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 300 is shown in FIG. 3, depicting an exemplary embodiment of a block diagram of an exemplary computer system useful for implementing the present invention. Specifically, FIG. 3 illustrates an example computer 300, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/7/VISTA,etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. Other components of the invention, such as, e.g., (but not limited to) a computing device, a communications device, a telephone, a smartphone (e.g., an iPhone, a Droid, etc.), a mobile computing device (e.g., an iPad or a netbook), a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 3.

The computer system 300 may include one or more processors, such as, e.g., but not limited to, processor(s) 304. The processor(s) 304 may be connected to a communication infrastructure 306 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 300 may include a display interface 302 that may forward, e.g., but not limited to, graphics, text, and other data, etc., from the communication infrastructure 306 (or from a frame buffer, etc., not shown) for display on the display unit 330.

The computer system 300 may also include, e.g., but may not be limited to, a main memory 308, random access memory (RAM), and a secondary memory 310, etc. The secondary memory 310 may include, for example, (but may not be limited to) a hard disk drive 312 and/or a removable storage drive 314, representing a floppy diskette drive, a magnetic tape drive, an optical disk drive, a magneto-optical disk drive, a compact disk drive CD-ROM, a digital versatile disk (DVD), a write once read many (WORM) device, a flash memory device, etc. The removable storage drive 314 may, e.g., but not limited to, read from and/or write to a removable storage unit 318 in a well known manner. Removable storage unit 318, also called a program storage device or a computer program product, may represent, e.g., but not limited to, a floppy disk, a magnetic tape, an optical disk, a magneto-optical disk, a compact disk, a flash memory device, etc. which may be read from and written to by removable storage drive 314. As will be appreciated, the removable storage unit 318 may include a computer usable storage medium having stored therein computer software and/or data.

In alternative exemplary embodiments, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 322 and interfaces 320, which may allow software and data to be transferred from the removable storage unit 322 to computer system 300.

Computer 300 may also include an input device 316 such as, e.g., (but not limited to) a mouse or other pointing device such as a digitizer, a keyboard or other data entry device (none of which are labeled), and/or a touchscreen integrated with display 330, etc.

Computer 300 may also include output devices 332, such as, e.g., (but not limited to) display 330, and display interface 302. Computer 300 may include input/output (I/O) devices such as, e.g., (but not limited to) communications interface 324, cable 328 and communications path 326, etc. These devices may include, e.g., but not limited to, a network interface card, and modems (neither are labeled). Communications interface 324 may allow software and data to be transferred between computer system 300 and external devices. Examples of communications interface 324 may include, e.g., but may not be limited to, a modem, a network interface (such as, e.g., an Ethernet card), a communications port, a Personal Computer Memory Card International Association (PCMCIA) slot and card, a transceiver, a global positioning system receiver, etc. Software and data transferred via communications interface 324 may be in the form of signals 328 which may be electronic, electromagnetic, optical or other signals capable of being received by communications interface 324. These signals 328 may be provided to communications interface 324 via, e.g., but not limited to, a communications path 326 (e.g., but not limited to, a channel). This channel 326 may carry signals 328, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 314, a hard disk installed in hard disk drive and/or other storage device 312, etc. These computer program products may provide software to computer system 300. The invention may be directed to such computer program products.

Computer programs (also called computer control logic), may include object oriented computer programs, and may be stored in main memory 308 and/or the secondary memory 310 and/or removable storage drive 314, removable storage unit 318, removable storage unit 322, also called computer program products. Such computer programs, when executed, may enable the computer system 300 to perform the features of the present invention as discussed herein. In particular, the computer programs, when executed, may enable the processor or processors 304 to provide a method to control and/or manage operation of a positioning effect detection device according to an exemplary embodiment of the present invention. Accordingly, such computer programs may represent coordinators of the computer system 300.

In another exemplary embodiment, the invention may be directed to a computer program product comprising a computer readable medium having control logic (computer software) stored therein. The control logic, when executed by the processor 304, may cause the processor 304 to perform the functions of the invention as described herein. In another exemplary embodiment where the invention may be implemented using software, the software may be stored in a computer program product and loaded into computer system 300 using, e.g., but not limited to, removable storage drive 314, hard drive 312 or communications interface 324, etc. The control logic (software), when executed by the processor 304, may cause the processor 304 to perform the functions of the invention as described herein. The computer software may run as a standalone software application program running atop an operating system, or may be integrated into the operating system.

While various embodiments have been described above, it should be understood that they have been presented by way of example only, and not limitation. Thus, the breadth and scope of the described should not be limited by any of the above-described exemplary embodiments, but should instead be defined only in accordance with the following claims and their equivalents.

1. A method for providing a medical digital image on a device, the method comprising:
receiving, using the device, a medical digital image from an image depot;
receiving, using the device, an advertisement;
presenting the advertisement on a display of the device; and
presenting the medical digital image on the display of the device.

2. The method of claim 1, wherein the presentation of the medical digital image is based on the presentation of the advertisement.

3. The method of claim 1, wherein the presentation of the advertisement is based on the presentation of the medical digital image.

4. The method of claim 1, further comprising:
requesting, using the device, the medical digital image from the image depot,
wherein the receiving of the medical digital image is based on the request of the medical digital image.

5. The method of claim 1, further comprising:
notifying the image depot of the presentation of the advertisement.

6. The method of claim 1, further comprising:
querying the image depot for notifications;
receiving a notification from the image depot; and
presenting the notification to a user of the device.

7. The method of claim 1, further comprising:
receiving a notation associated with the medical digital image from a user of the device;
sending the notation to the image depot;
receiving a second notation associated with the medical digital image from a second device via the image depot; and
presenting the second notation on the display of the device.

8. The method of claim 1, wherein the advertisement comprises at least one of: a wallpaper advertisement, a video advertisement, a pop-up advertisement, a polite advertisement, or an interstitial advertisement.

9. The method of claim 1, further comprising:
determining the presentation of the advertisement should be delayed; and
scheduling the presentation of the advertisement for a later point in time,
wherein the presentation of the advertisement occurs at the later point in time.

10. The method of claim 1, wherein the receiving of the medical digital image occurs before the receiving of the advertisement and wherein the presentation of the medical digital image occurs before the presentation of the advertisement.

11. The method of claim 1, wherein if there is a delay in receiving or displaying the advertisement, the medical digital image will nevertheless be received and displayed.

12. A method for providing a medical digital image, the method comprising:
receiving, using a computer, a medical digital image from an image provider;
receiving, using the computer, an advertisement from an advertisement device;
determining, using the computer, the medical digital image should be sent to a user device;
sending, using the computer, the medical digital image to the user device based on the determination; and
sending, using the computer, the advertisement to the user device based on the determination.

13. The method of claim 12, wherein the determination the medical digital image should be sent to the user device is based on at least one of:
receiving an image request from a user device; or
determining the medical digital image should be viewed by a user of the user device.

14. The method of claim 12, wherein the sending of the advertisement comprises sending an advertisement based on at least one of:
the contents of the medical digital image;
the patient data associated with the medical digital image;
user data associated with a user authorized to receive the medical digital image; or user device data.

15. The method of claim 12, further comprising:
receiving a notification the advertisement was presented by the user device;

16. The method of claim 12, further comprising:
tracking payment due by an advertiser based on the sending of the advertisement.

17. The method of claim 12, further comprising:
receiving a query for notifications from the user device; and
sending a notification to the user device in response to the query.

18. The method of claim 12, further comprising:
receiving a notation associated with a medical digital image from a user device; and
sending the notation to a second user device.

19. The method of claim 18, further comprising:
receiving a second notation from the second user device; and
sending the second notation to the user device.

20. The method of claim 12, wherein sending the notation to a second user device comprises sending the notation in real-time.

21. The method of claim 12, further comprising:
associating an electronic medical record with the medical digital image; and
sending the electronic medical record based on the sending of the medical digital image.

22. The method of claim 12, further comprising:
associating the medical digital image with a user account; and
authenticating a user of the user device,
wherein the sending of the medical digital image is based on authorizing the authenticated user to receive the medical digital image associated with the user account.

23. The method of claim 12, further comprising:
initiating a telephone call to the user device based on the receiving of the medical digital image.

24. A medium holding computer-executable instructions for operating a programming environment using a computer, the instructions comprising instructions for:
receiving a medical digital image from an image provider;
associating the medical digital image with a user account;
receiving an advertisement from an advertisement device;
receiving an image request associated with a user of a user device;
verifying the user associated with the user device corresponds with the user account associated with the image request;
sending the medical digital image based on the verification; and
sending, using the computer, the advertisement to the user device based on the sending of the medical digital image.
